(19) United States
(12) Patent Application Publication
(10) Pub. No.: US 2025/0060781 A1
(43) Pub. Date: Feb. 20, 2025

(54) WEARABLE ELECTRONIC DEVICE

(71) Applicant: SAMSUNG ELECTRONICS CO., LTD., Suwon-si (KR)

(72) Inventors: Jinyong KIM, Suwon-si (KR); Jonghwan KIM, Suwon-si (KR); Taiyong KIM, Suwon-si (KR); Wonju SEO, Suwon-si (KR); Hakhoon SONG, Suwon-si (KR); Yonghoon LEE, Suwon-si (KR); Jeock LEE, Suwon-si (KR)

(21) Appl. No.: 18/802,180

(22) Filed: Aug. 13, 2024

Related U.S. Application Data
(63) Continuation of application No. PCT/KR2024/010822, filed on Jul. 25, 2024.

(30) Foreign Application Priority Data
Aug. 16, 2023 (KR) 10-2023-0106963
Sep. 19, 2023 (KR) 10-2023-0124846

(51) Int. Cl. G06F 1/16; G06F 3/16

(52) U.S. Cl. CPC G06F 1/163; G06F 3/162; G06F 3/165

(57) ABSTRACT

A wearable electronic device including a housing forming an exterior of the wearable electronic device, a first sound conduit and a second sound conduit disposed in an internal space of the housing, a nozzle part through which the audio signals transmit both into and out of the housing, the nozzle part including an end surface of the housing, a partition wall in the internal space of the housing and spatially separating the internal space into the first sound conduit and the second sound conduit, a speaker disposed to correspond to the first sound conduit in the internal space of the housing, and a microphone disposed to correspond to the second sound conduit in the internal space of the housing.

### CROSS-REFERENCE TO RELATED APPLICATIONS

This application is a continuation application of International Application No. PCT/KR2024/010822 designating the United States, filed on Jul. 25, 2024, in the Korean Intellectual Property Receiving Office and claiming priority to Korean Patent Application No. 10-2023-0106963, filed on Aug. 16, 2023, and Korean Patent Application No. 10-2023-0124846, filed on Sep. 19, 2023, in the Korean Intellectual Property Office, the disclosures of which are incorporated by reference herein in their entireties.

### BACKGROUND

### (1) Field

Embodiments of the disclosure relate to a wearable electronic device.

### (2) Description of the Related Art

With the growth of digital technology, electronic devices are provided in a variety of forms such as bar-type, foldable-type, rollable-type, or sliding-type smartphones, tablet personal computers (PCs), or personal digital assistants (PDAs). In one example, the electronic device may include a wearable electronic device implemented in a form which can be inserted into or coupled with a body part of a user of the wearable electronic device. For example, a pair of wearable electronic devices may operate wirelessly while inserted into or in close contact with a body part, such as one or more ear of the user. The wearable electronic device may include a speaker, a microphone, and a nozzle for separating an internal space of the body part like an eardrum from an external space outside of the body part. For example, the microphone may include an active noise canceling (ANC) microphone to remove an audio signal which constitutes noise inside the wearable electronic device. The wearable electronic device can analyze sound waves of surrounding audio sounds using the microphone and output opposing sound waves for canceling out the surrounding audio sounds through the speaker to remove noise, thereby outputting relatively enhanced audio signals.

### SUMMARY

When the nozzle of the wearable electronic device is clogged, not only a recursive audio signal is formed between the speaker and the microphone, but also the front volume of the speaker changes, which may vary speaker-microphone features. Thus, the speaker-microphone gain in a specific frequency band may increase or the phase may become distorted, resulting in howling and/or echo.

A wearable electronic device according to an embodiment of the disclosure may include a partition wall portion which spatially separates a speaker and a microphone.

According to an embodiment of the disclosure, a wearable electronic device may include a housing forming an exterior of the wearable electronic device. According to an embodiment, the wearable electronic device may includes a first sound conduit and a second sound conduit disposed in an internal space of the housing. According to an embodiment, the wearable electronic device may include a nozzle part through which the audio signals transmit both into and out of the housing. The nozzle part including an end surface of the housing. According to an embodiment, the wearable electronic device may include a partition wall in the internal space of the housing and spatially separating the internal space into the first sound conduit and the second sound conduit. According to an embodiment, the wearable electronic device may include a speaker disposed to correspond to a first sound conduit in an internal space of the housing. According to an embodiment, the wearable electronic device may include a microphone disposed to correspond to a second sound conduit in the internal space of the housing. According to an embodiment, a portion of the partition wall portion may be extend further than the end surface of the housing.

In the wearable electronic device according to an embodiment of the disclosure, as the speaker and microphone are spatially separated through the partition wall portion, audio signals outputted from the speaker and transmitted to the microphone are reduced in a situation where the nozzle is clogged, and thus a recursive signal may not be formed between the speaker and microphone. Accordingly, the features between the speaker and the microphone do not change, so not only does howling and/or echo not occur, but also active noise canceling (ANC) performance can be improved.

### BRIEF DESCRIPTION OF THE DRAWINGS

The above and other advantages and features of this disclosure will become more apparent by describing in further detail embodiments thereof with reference to the accompanying drawings, in which:

FIG. 1 is a block diagram of an electronic device in a network environment according to an embodiment of the disclosure.

FIGS. 2A and 2B are side and cross-sectional diagrams respectively schematically illustrating a wearable electronic device according to an embodiment of the disclosure.

FIG. 3 is a diagram illustrating active noise canceling according to an embodiment of the disclosure.

FIGS. 4A and 4B are cross-sectional diagrams illustrating active noise canceling of a wearable electronic device according to an embodiment of the disclosure.

FIGS. 5A and 5B are cross-sectional diagrams illustrating the shapes of a partition wall portion and a grill of a wearable electronic device according to an embodiment of the disclosure.

FIGS. 6A and 6B are cross-sectional diagrams illustrating the shapes of a partition wall portion and a grill of a wearable electronic device according to an embodiment of the disclosure.

FIG. 7 is a cross-sectional diagram illustrating the shape of a partition wall portion of a wearable electronic device according to an embodiment of the disclosure.

FIGS. 8A and 8B are perspective diagrams illustrating at least one extension opening in a housing of a wearable electronic device according to an embodiment of the disclosure.

FIG. 9 is a cross-sectional diagram illustrating the shape of a partition wall portion of a wearable electronic device according to an embodiment of the disclosure.

FIG. 10A is a graph showing the frequency response of a microphone in a conventional case where the microphone is not spatially separated from a speaker, according to an embodiment of the disclosure.

FIG. 10B is a graph showing the frequency response of a microphone in the case where the microphone is spatially separated from a speaker by a partition wall portion, according to an embodiment of the disclosure.

FIG. 11 is a graph showing active noise canceling performance in the case where a speaker and a microphone are spatially separated by a partition wall portion, according to an embodiment of the disclosure.

### DETAILED DESCRIPTION

Hereinafter, embodiments of the disclosure will be described in detail with reference to the drawings so that those skilled in the art to which the disclosure pertains can easily implement the disclosure. However, the present disclosure may be implemented in various forms and is not limited to embodiments set forth herein. With regard to the description of the drawings, the same or like reference signs may be used to designate the same or like elements. Also, in the drawings and the relevant descriptions, description of well-known functions and configurations may be omitted for the sake of clarity and brevity.

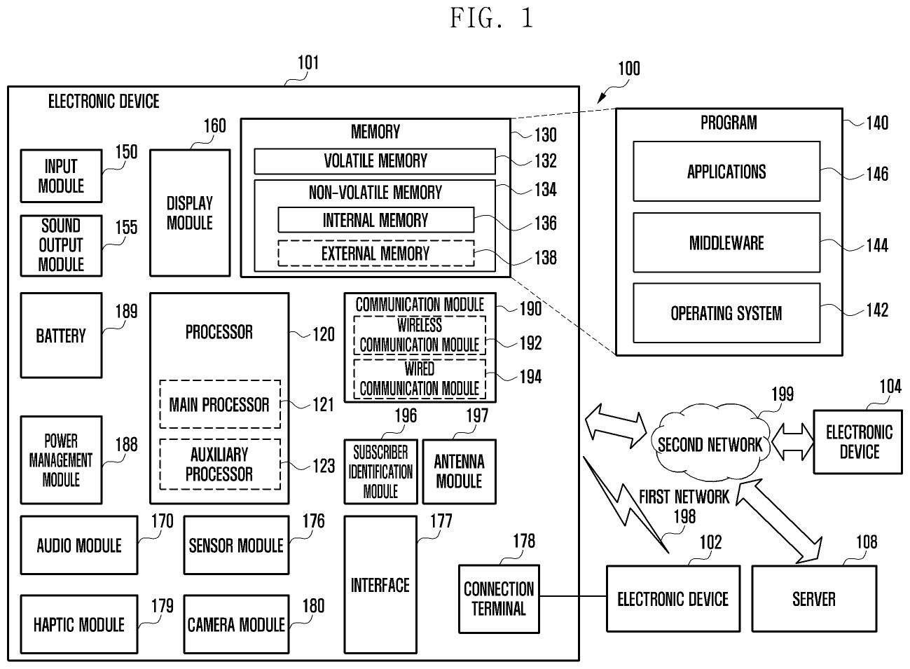

FIG. 1 is a block diagram illustrating an electronic device 101 in a network environment 100 according to various embodiments.

Referring to FIG. 1, an electronic device 101 in a network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connection terminal 178, a haptic module 179, a camera module 180, a power management module 188, a battery 189, a communication module 190, a subscriber identification module (SIM) 196, or an antenna module 197. In some embodiments, at least one of the components (e.g., the connection terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134. The non-volatile memory 134 may include an internal memory 136 and/or an external memory 138.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls.

According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) (e.g., speaker or headphone) directly (e.g., wiredly) or wirelessly coupled with the electronic device 101.

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., through wires) or wirelessly. According to an embodiment, the interface 177 may include, for example, a high-definition multimedia interface (HDMI), a universal serial bus (USB) interface, a secure digital (SD) card interface, or an audio interface.

The connection terminal 178 may include a connector via which the electronic device 101 may be physically connected with the external electronic device (e.g., the electronic device 102). According to an embodiment, the connection terminal 178 may include, for example, an HDMI connector, a USB connector, an SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., an application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™ Wi-Fi direct, or infrared data association (IrDA)) or the second network 199 (e.g., a long-range communication network, such as a legacy cellular network, a fifth generation (5G) network, a next-generation communication network, the Internet, or a computer network (e.g., LAN or wide area network (WAN))). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large-scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., an mmwave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

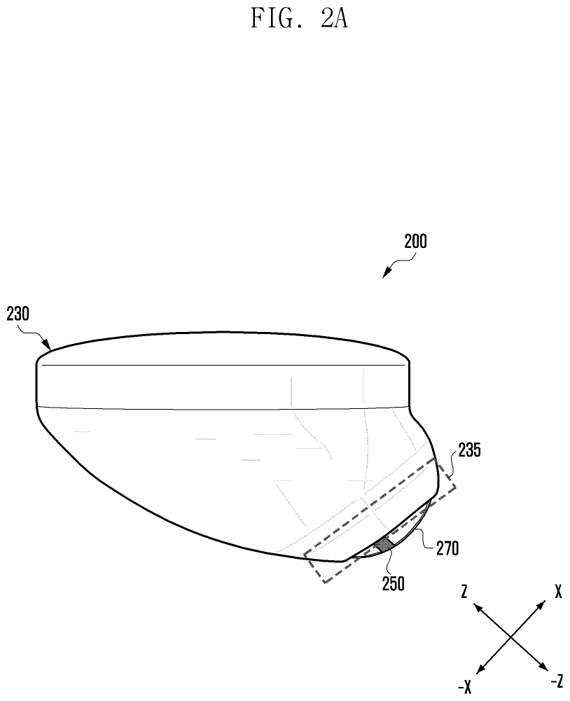

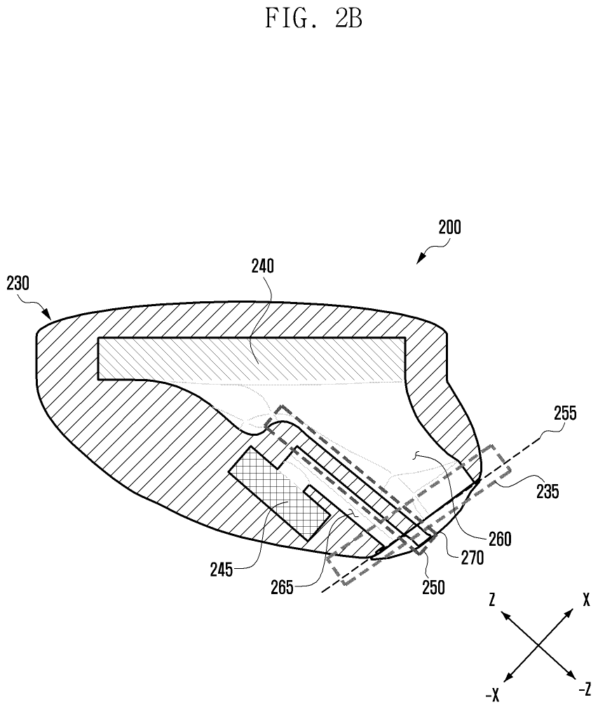

FIGS. 2A and 2B are diagrams schematically illustrating a wearable electronic device 200 according to an embodiment of the disclosure.

In various embodiments, the wearable electronic device 200 of FIG. 2 may include components and embodiments described in the electronic device 101 shown in FIG. 1. For example, the wearable electronic device 200 may include the input module 150, the sound output module 155, and the audio module 170 shown in FIG. 1.

The wearable electronic device 200 may be a wearable type wireless audio device designed to be interfaced with a body part of a user of the wearable electronic device 200. In an embodiment, the wearable electronic device 200 may be an ear wearable type wireless audio device designed to be worn in one or more of the user's ears. Although FIGS. 2A and 2B illustrate one wearable type wireless audio device, one set of ear wearable type wireless audio devices may be implemented as the one wearable type wireless audio device provided in plural. For example, it is possible to include a first wireless audio device designed to be worn on the user's left ear and a second wireless audio device designed to be worn on the user's right ear.

With reference to FIGS. 2A and 2B, the wearable electronic device 200 (e.g., the electronic device 101 in FIG. 1) may include a housing 230, a nozzle part 235, a speaker 240 (e.g., the sound output module 155 in FIG. 1), a microphone 245 (e.g., the input module 150 in FIG. 1), a partition wall portion 250, a first sound conduit 260, a second sound conduit 265, and/or a grill 270.

In an embodiment, the housing 230 may form at least a portion of the exterior of the wearable electronic device 200. A portion of the housing 230 may be insertable into a body part such as the ear of the user of the wearable electronic device 200. At least a portion of the housing 230 may have a shape which is attachable/detachable to/from the ear (e.g., external auditory canal) of the user of the wearable electronic device 200.

In an embodiment, at least a portion of the housing 230 may have various materials such as polymer and/or metal. For example, at least a portion of the housing 230 may be formed of (or include) a rigid material.

In an embodiment, the wearable electronic device 200 may include the speaker 240 and the microphone 245 each disposed in an internal space of the housing 230. Although not shown, the wearable electronic device 200 may further include a battery (e.g., the battery 189 in FIG. 1) disposed in the internal space of the housing 230.

In an embodiment, the speaker 240 may be disposed spaced apart from the microphone 245 within the internal space of the housing 230. The speaker 240 may convert an electrical signal into an audio signal (e.g., a sound) and transmit at least in part the audio signal (e.g., sound) to the eardrums of the user of the wearable electronic device 200 through the first sound conduit 260. The speaker 240 may be configured to allow the user of the wearable electronic device 200 to listen to various types of sound-related information such as playable music or playable multimedia.

The first sound conduit 260 may be exposed to the eardrum of the user of the wearable electronic device 200, such as to be in audio communication with the body part of the user. Where the audio signal from the speaker 240 transmits along the internal space of the housing 230, to the first sound conduit 260 and finally through the first sound conduit 260 to outside the wearable electronic device 200, an audio transmission path (e.g., a first audio transmission path) may be defined within the internal space of the housing 230.

In an embodiment, the speaker 240 may output offset an audio signal constituting noise to remove the noise detected by the microphone 245. For example, the speaker 240 generates noise having an opposite phase (e.g., noise representing a frequency with an opposite phase) to noise detected by the microphone 245 so as to cancel the noise, thereby performing active noise canceling (ANC).

In an embodiment, the microphone 245 may include a microphone for active noise canceling to remove noise inside the wearable electronic device 200. In an embodiment, the microphone 245 may detect noise through the second sound conduit 265 as a second audio transmission path.

In an embodiment, the nozzle part 235 may be formed (or provided) integrally with a portion of the housing 230. For example, the nozzle part 235 may be formed in a cylindrical shape. In an embodiment, the nozzle part 235 may include (or define) an end portion of the first sound conduit 260 through which audio signals outputted from the speaker 240 are provided to outside the housing 230, and an end portion of the second sound conduit 265 through which audio signals received by the microphone 245 are provided from outside the housing 230. In an embodiment, the nozzle part 235 may form a portion of the housing 230. At least a portion of the nozzle part 235 may be worn by a user such as by being inserted into the ear (e.g., external auditory canal) as a body part of the user of the wearable electronic device 200. The nozzle part 235 may define an audio input (or inlet) and/or an audio output (or outlet) of the housing 230.

In an embodiment, the wearable electronic device 200 may include the partition wall portion 250 which extends from a portion of the housing 230 and spatially separates the speaker 240 and the microphone 245 disposed in the internal space of the housing 230 of the wearable electronic device 200. A portion of the partition wall portion 250 may extend from a portion of the housing 230 and protrude outward (e.g., in the negative z-axis direction) beyond one surface 255 of the nozzle part 235. That is, the partition wall portion 250 may be considered an integral part of the housing 230.

The one surface 255 may represent a plane defined by the dotted line indicated by 255 and extended in a direction into the page view. For example, FIGS. 2A and 2B illustrate views of a plane defined by a first direction (e.g., the x-axis direction) crossing a second direction (e.g., the z-axis direction). The plane at the one surface 255 may be defined by the first direction crossing a third direction (e.g., into the page).

An opening in the housing 230 at which the internal space of the housing 230 is in audio connection with outside of the housing 230 may be defined along such plane. A distal end of the housing 230 may be disposed in the plane. The partition wall portion 250 is spaced apart from inner sidewalls of the housing 230 which face each other in a direction along the plane and define the opening therebetween. A body of the housing 230 may define each of the partition wall portion 250, and sidewall portions which define inner sidewalls of the housing 230 facing the partition wall portion 250. That is, the body of the housing 230 may be a unitary body, without being limited thereto.

A first gap or first space is defined between a first sidewall of the partition wall portion 250 and a first inner sidewall of the housing 230, and an audio outlet of the housing 230 (e.g., at the distal end of the first sound conduit 260) corresponds to the first gap. A second gap or second space is defined between a second sidewall of the partition wall portion 250 which is opposite to the first sidewall, and a second inner sidewall of the housing 230, and an audio inlet of the housing 230 (e.g., at the end of the second sound conduit 265) corresponds to the second gap. Distal ends of the first inner sidewall and the second inner sidewall may be coplanar with each other, e.g., in the plane defined at the one surface 255, whereas the end of the partition wall portion 250 is non-coplanar with the one surface 255.

The grill 270 may extend completely across the (audio) opening of the housing 230. In embodiments, even though the grill 270 is overlaps the audio opening defined at the nozzle part 235, sound may pass through the grill 270. That is, the grill 270 is a sound-permeable (or audio signal-permeable) member through which audio signals or sound may enter into an internal area of the housing 230 from outside thereof and/or exit to an area external to the housing 230 from inside thereof.

In an embodiment, a portion of the partition wall portion 250 which extends from a portion of the housing 230 and protrudes outward (e.g., in the negative z-axis direction) beyond the one surface 255 of the nozzle part 235 may be included in the nozzle part 235. For example, the nozzle part 235 may include the end portion of the first sound conduit 260 which is an outlet of the path of audio signals outputted from the speaker 240, the end portion of the second sound conduit 265 which is an inlet of the path of audio signals inputted to the microphone 245, and the end portion of the partition wall portion 250 formed to protrude outward (e.g., in the negative z-axis direction) and further than the one surface 255 of the nozzle part 235. Each of the end portions described above may be considered a distal end of the respective feature. One or more of the distal ends may be exposed to outside the housing 230 (or outside the wearable electronic device 200, such that a sound-receiving portion of the body part (e.g., the auditory canal) is exposed to such distal ends.

In an embodiment, the wearable electronic device 200 may include the grill 270 detachably combined with the nozzle part 235 (or fixed to the nozzle part 235 to be non-detachable). The grill 270 may be variously detachably attached to or non-detachably attached to the body of the housing 230 at a distal end of the body at opposing sides of the partition wall portion 250 and at the partition wall portion 250. In an embodiment, the grill 270 may be disposed to extend from a portion of the housing 230 and surround the one surface 255 of the nozzle part 235 and a portion of the partition wall portion 250 protruding outward (e.g., in the negative z-axis direction) from the one surface 255 of the nozzle part 235. For example, the grill 270 may be formed in an arch shape in cross-section. However, it is not limited to this.

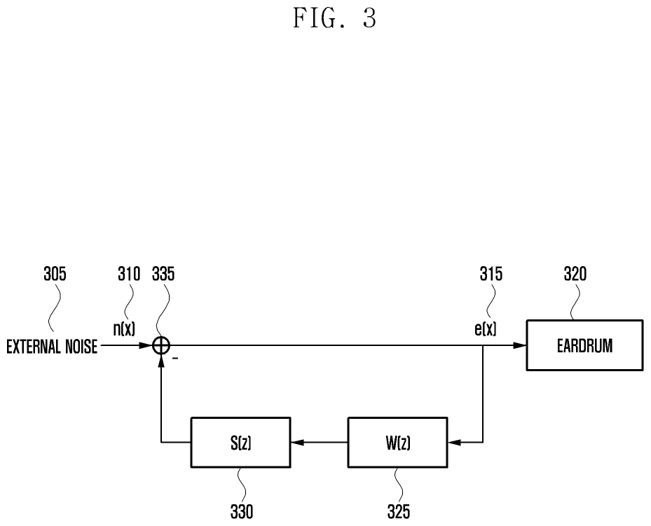

FIG. 3 is a diagram illustrating active noise canceling according to an embodiment of the disclosure.

With reference to FIG. 3, when the active noise canceling function is operating while the wearable electronic device (e.g., the electronic device 101 in FIG. 1, the wearable electronic device 200 in FIGS. 2A and 2B) is mounted on or engaged with a body part such as the user's ear, the microphone (e.g., the microphone 245 in FIGS. 2A and 2B) may detect external noise 305. The external noise 305 may be provided from outside the wearable electronic device 200. The external noise 305 may be provided as an input value n(x) 310 to a filter function W(z) 325 and a transfer function S(z) 330, by a closed-loop control system. Using n(x) 310, the filter function W(z) 325 may generate offset noise. The speaker (e.g., the speaker 240 in FIGS. 2A and 2B) may output the generated offset noise. The wearable electronic device 200 may measure the transfer function S(z) 330 between the speaker 240 and the microphone 245. The transfer function S(z) 330 may reflect the features of noise outputted from the speaker 240 being transformed in the process of reaching the microphone 245.

In an embodiment, the wearable electronic device 200 may perform a multiplication operation of the filter function W(z) 325 and the transfer function S(z) 330 and then perform an addition calculation 335 with n(x) 310 to obtain an output value e(x) 315, which is transmitted to the body part (e.g., the eardrum 320).

In an embodiment, the transfer function of ANC performance may be calculated based on Equation 1 below. The smaller the calculated transfer function of the ANC performance, the higher the ANC performance.

1/1+S(z)W(z) Equation 1

In an embodiment of the disclosure, since the speaker 240 and the microphone 245 are spatially separated within an internal space of the housing 230 by the partition wall portion (e.g., the partition wall portion 250 in FIGS. 2A and 2B), the transfer function S(z) 330, which means the features of noise outputted from the speaker 240 being transformed in the process of reaching the microphone 245, may not be performed. That is, providing of an audio signal from the speaker 240 to the microphone 245 may be reduced or effectively prevented. In this case, the speaker 240 may be implemented to more accurately generate cancelling noise having an opposite phase (e.g., noise representing a frequency with an opposite phase) to noise detected by the microphone 245 so as to cancel the external noise 305, thereby increasing ANC performance.

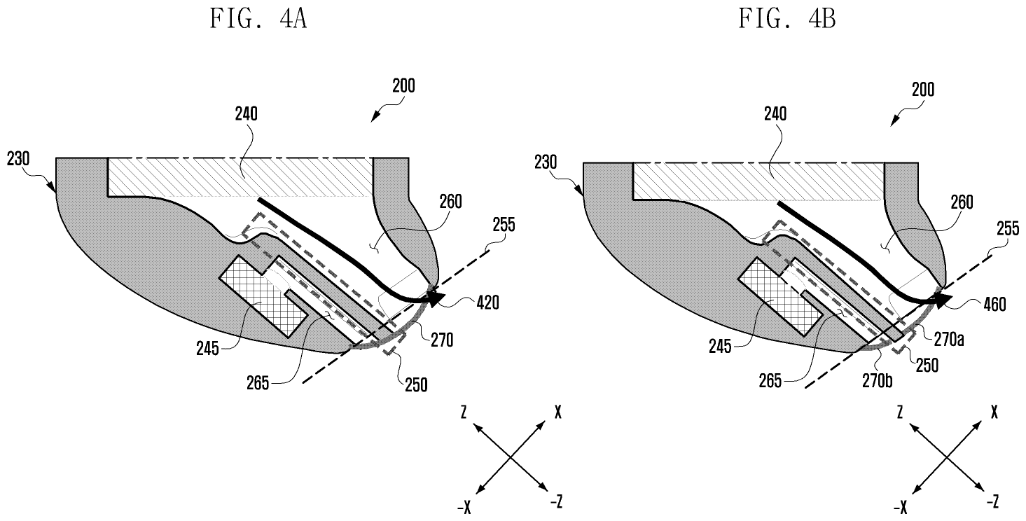

FIGS. 4A and 4B are cross-sectional diagrams illustrating active noise canceling of a wearable electronic device 200 according to an embodiment of the disclosure.

In the wearable electronic device 200 shown in FIGS. 4A and 4B according to an embodiment, a housing 230, a nozzle part 235, a speaker 240, a microphone 245, a partition wall portion 250, a first sound conduit 260, and a second sound conduit 265 are substantially the same as the housing 230, the nozzle part 235, the speaker 240, the microphone 245, the partition wall portion 250, the first sound conduit 260, and the second sound conduit 265 of the wearable electronic device 200 shown in FIGS. 2A and 2B, so the description thereof can be replaced by the above description in FIGS. 2A and 2B.

With reference to FIGS. 4A and 4B, the wearable electronic device 200 (e.g., the electronic device 101 in FIG. 1) may include the housing 230, the nozzle part 235, the speaker 240 (e.g., the sound output module 155 in FIG. 1), the microphone 245 (e.g., the input module 150 in FIG. 1), the first sound conduit 260, the second sound conduit 265, and/or the grill 270.

In an embodiment, the wearable electronic device 200 may include, as a part of the housing 230, the partition wall portion 250 which is an extended portion of the housing 230 and spatially separates the speaker 240 and the microphone 245 disposed in the internal space of the housing 230 from each other. The partition wall portion 250 may be formed to extend from a body portion of the housing 230 and protrude outward (e.g., in the negative z-axis direction) from the one surface 255 of the nozzle part 235.

In an embodiment, the microphone 245 may detect noise from outside the wearable electronic device 200, through the second sound conduit 265. The speaker 240 may perform the ANC function by generating noise having an opposite phase (e.g., noise representing a frequency with an opposite phase) to the detected noise from the microphone 245, so as to cancel the detected noise, within the wearable electronic device 200. The noise-cancelling function may be performed electronically, within the wearable electronic device 200, such as by using one or more features of the block diagram of an electronic device in a network environment described above.

In an embodiment, the nozzle part 235 may include an end portion of the first sound conduit 260 which is an output path of audio signals outputted from the speaker 240, and an end portion of the second sound conduit 265 which is a, input path of audio signals received by the microphone 245. At least a portion of the nozzle part 235 may be worn by being inserted into the ear (e.g., external auditory canal) of the user of the wearable electronic device 200. A portion of the wearable electronic device 200 may overlap the body part, such as to be inside thereof, while another portion of the wearable electronic device 200 extends outside of the body part to be outside of the body of the user, without being limited thereto. The portion of the wearable electronic device 200 shown in FIGS. 4A and 4B may be a first (internal) portion of the wearable electronic device 200 which is insertable into the body part to overlap the body part, while a remainder of the wearable electronic device 200 (portions in FIGS. 2A and 2B, except for those portions in FIGS. 4A and 4B), may be a second (external) portion of the wearable electronic device 200 which is outside of the body part when the wearable electronic device 200 overlaps the body part.

In an embodiment, the wearable electronic device 200 may include the grill 270 detachably combined with the nozzle part 235. It is not limited to this, and the grill 270 may be formed to be fixed to (e.g., non-detachable from) the nozzle part 235.

For example, FIG. 4A shows the grill 270 may be disposed to surround the one surface 255 of the nozzle part 235 and a portion of the partition wall portion 250 protruding outward (e.g., in the negative z-axis direction) from one surface 255 of the nozzle part 235. In this case, a portion of the partition wall portion 250 which protrudes outward (e.g., in the negative z-axis direction) from one surface 255 of the nozzle part 235 may be in contact with an inner surface of the grill 270. For example, the grill 270 may be formed in a curved shape. Here, an entirety of the partition wall portion 250 is on an inner side of the grill 270

For another example, FIG. 4B shows the grill 270 may include a first grill 270a disposed to surround at least a portion of the one surface 255 of the nozzle part 235 and one side of the portion of the partition wall portion 250 protruding outward (e.g., in the negative z-axis direction) from the one surface 255 of the nozzle part 235. Also, the grill 270 may include a second grill 270b disposed to surround at least another portion of the one surface 255 of the nozzle part 235 and the other side of the portion of the partition wall portion 250 protruding outward (e.g., in the negative z-axis direction) from the one surface 255 of the nozzle part 235.

Here, the first grill portion (e.g., the first grill 270a) and the second grill portion (e.g., the second grill 270b) may be separated from each other with the partition wall portion 250 therebetween. The grill 270 may be disconnected at the partition wall portion 250, to define the first grill portion and the second grill portion disconnected from each other along the plane defined at the one surface 255.

The first grill portion and the second grill portion may be variously detachably attached to or non-detachably attached to the body of the housing 230, such as at side surfaces of the partition wall portion 250 (refer to FIG. 4B, for example), at an end surface of the partition wall portion 250 (refer to FIG. 4A, for example), at a distal end of the body at opposing sides of the partition wall portion 250, etc. As used herein, positions within the various Figures at which grill portions respectively meet the body of the housing 230 may disclose an attachment position at which a grill portion is detachably attached (or un-detachably attached) to the housing 230.

In an embodiment, since the partition wall portion 250 extends from a portion of the housing 230 and protrudes outward (e.g., in the negative z-axis direction) beyond the one surface 255 of the nozzle part 235 and spatially separates the speaker 240 and the microphone 245 disposed in the internal space of the housing 230 of the wearable electronic device 200, the wearable electronic device 200 can analyze the sound waves of ambient noise using the microphone 245 and generate opposite sound waves for canceling out the ambient noise using the speaker 240 to remove the ambient noise, thereby outputting relatively enhanced audio signals.

In an embodiment, when the nozzle part 235 of the wearable electronic device 200 is clogged (e.g., when the nozzle part 235 is blocked by the user's hand), audio signals 420 and 460 outputted from the speaker 240 may be outputted through the first sound conduit 260. For example, when the audio opening at the nozzle part 235 is blocked, the audio signals 420 and 460 outputted from the speaker 240 through the first sound conduit 260 and transmitted to the microphone 245 through the second sound conduit 265, may be reduced or effectively prevented, by the partition wall portion 250. As a result, a recursive signal which causes howling or echo is not formed between the speaker 240 and the microphone 245, so the features between the speaker 240 and the microphone 245 may not change. For example, since an audio input path from the speaker 240 and the audio input path to the microphone 245 are spatially separated from each other by the partition wall portion 250, the audio signals outputted from the speaker 240 and transmitted to the microphone 245 are reduced even if the nozzle part 235 of the wearable electronic device 200 is blocked. Thus, the gain of the speaker 240 and the microphone 245 in a specific frequency band does not increase and the phase does not be distorted, so howling (and/or echo) may not occur.

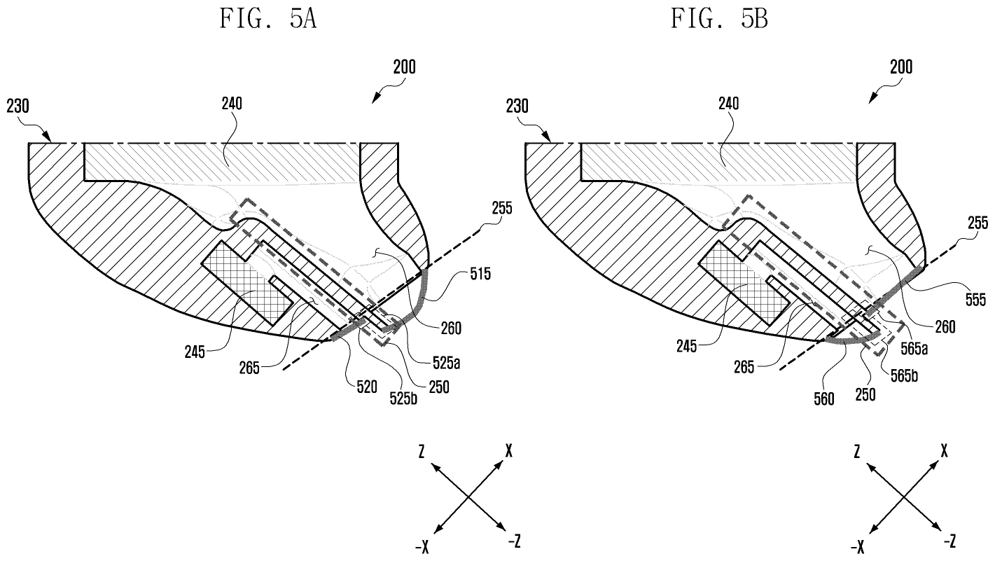

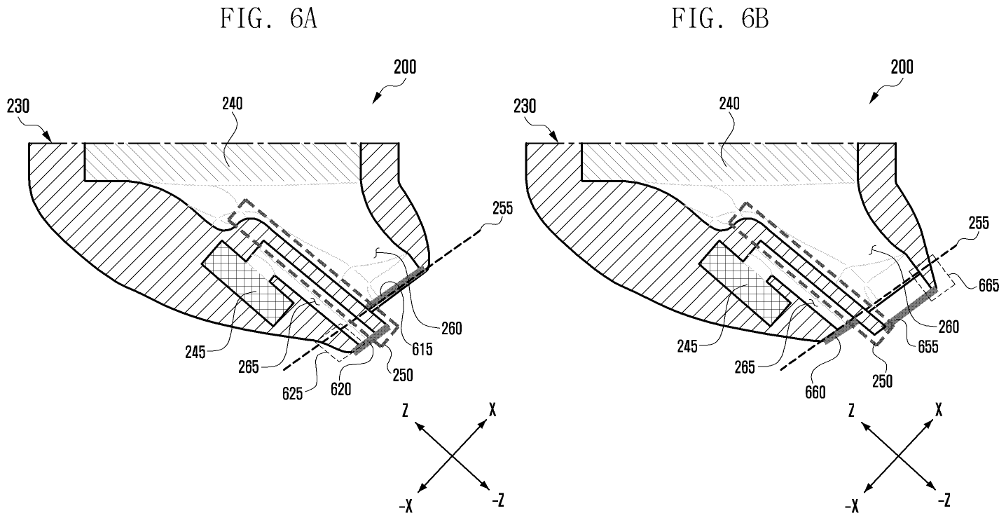

FIGS. 5A and 5B are cross-sectional diagrams illustrating the shapes of a partition wall portion 250 and a grill of a wearable electronic device 200 according to an embodiment of the disclosure.

In the wearable electronic device 200 shown in FIGS. 5A and 5B according to an embodiment, a housing 230, a nozzle part 235, a speaker 240, a microphone 245, a partition wall portion 250, a first sound conduit 260, and a second sound conduit 265 are substantially the same as the housing 230, the nozzle part 235, the speaker 240, the microphone 245, the partition wall portion 250, the first sound conduit 260, and the second sound conduit 265 of the wearable electronic device 200 shown in FIGS. 2A and 2B, so the description thereof can be replaced by the above description in FIGS. 2A and 2B.

With reference to FIGS. 5A and 5B, the wearable electronic device 200 may include the partition wall portion 250 which is formed to extend from a portion of the housing 230 and protrude outward (e.g., in the negative z-axis direction) from one surface 255 of the nozzle part 235. Since the partition wall portion 250 is formed to extend from a portion of the housing 230 and protrude outward (e.g., in the negative z-axis direction) beyond one surface 255 of the nozzle part 235, the partition wall portion 250 can spatially separate respective audio paths exposed to the speaker 240 and the microphone 245 disposed in the internal space of the housing 230 of the wearable electronic device 200.

In an embodiment, the partition wall portion 250 shown in FIGS. 5A and 5B may be formed to protrude further from (e.g., in the negative z-axis direction) the one surface 255 of the nozzle part 235 only at least in part, compared to the partition wall portion 250 shown in FIGS. 2A and 2B.

For example, as shown in FIG. 5A, at least one portion 525a of the partition wall portion 250 adjacent to the first sound conduit 260 may be formed to protrude outward (e.g., the negative z-axis direction) beyond the one surface 255 of the nozzle part 235. At least another portion 525b of the partition wall portion 250 adjacent to the second sound conduit 265 may be formed to have a length which can contact the one surface 255 of the nozzle part 235. Each of the portions 525a and 525b defines an end surface of the partition wall portion 250, where the end surface of the portion 525a is further from the one surface 255 than the end surface of the portion 525b. The end surface of the portion 525b may be coplanar with the one surface 255.

In an embodiment, the wearable electronic device 200 may include a grill detachably combined with the nozzle part 235 (or fixed to the nozzle part 235). For example, the grill may include a first grill 515 and a second grill 520. The first grill 515 may be disposed to surround at least one surface of the nozzle part 235 (e.g., at least one surface of the nozzle part 235 corresponding to the first sound conduit 260) and at least one portion 525a of the partition wall portion 250 formed to protrude outward (e.g., in the negative z-axis direction) beyond the one surface 255 of the nozzle part 235. The second grill 520 may be disposed to surround at least another surface of the nozzle part 235 (e.g., at least another surface of the nozzle part 235 corresponding to the second sound conduit 265) and the at least another portion 525b of the partition wall portion 250 formed to have a length ending at the one surface 255 of the nozzle part 235.

In an embodiment, the first grill 515 may be formed in a curved shape, and the second grill 520 may be formed in a shape parallel to the one surface 255 of the nozzle part 235. However, it is not limited to this. Here, the first grill 515 and the second grill 520 may be spaced apart from each other along the z-axis direction.

For another example, as shown in FIG. 5B, at least one portion 565a of the partition wall portion 250 adjacent to the first sound conduit 260 may be formed parallel to the one surface 255 of the nozzle part 235. At least another portion 565b of the partition wall portion 250 adjacent to the second sound conduit 265 may be formed to protrude outward (e.g., in the negative z-axis direction) beyond the one surface 255 of the nozzle part 235. Each of the portions 565a and 565b defines an end surface of the partition wall portion 250, where the end surface of the portion 565a is closer to the one surface 255 than the end surface of the portion 565b. The end surface of the portion 565a may be coplanar with the one surface 255.

In an embodiment, the wearable electronic device 200 may include a grill detachably combined with the nozzle part 235 (or fixed to the nozzle part 235). For example, the grill may include a first grill 555 and a second grill 560. The first grill 555 may be disposed to surround at least one surface of the nozzle part 235 (e.g., at least one surface of the nozzle part 235 corresponding to the first sound conduit 260) and the at least one portion 565a of the partition wall portion 250 formed parallel to the one surface 255 of the nozzle part 235. The second grill 560 may be disposed to surround at least another surface of the nozzle part 235 (e.g., at least another surface of the nozzle part 235 corresponding to the second sound conduit 265) and the at least another portion 565b of the partition wall portion 250 formed to protrude outward (e.g., in the negative z-axis direction) beyond the one surface 255 of the nozzle part 235.

In an embodiment, the first grill 555 may be formed in a shape parallel to the one surface 255 of the nozzle part 235, and the second grill 560 may be formed in a curved shape. However, it is not limited to this.

In an embodiment, the partition wall portion 250 has a stepped shape at an end portion thereof. A thickness of the partition wall portion 250 may be defined in a direction parallel to the plane at the one surface 255. Along the z-axis direction, a first thickness of the partition wall portion 250 is at an inner side of the plane (e.g., 525b and 565a), while a second thickness of the partition wall portion 250 is at an outer side of the plane (e.g., extending further than the plane in the negative z-axis direction, like 525a and 565b). The first thickness is greater than the second thickness. In FIG. 5A, the step faces the second sound conduit 265, while in FIG. 5B, the step faces the first sound conduit 260.

The first grill portion (e.g., the first grill 555) and the second grill portion (e.g., the second grill 560) may be variously detachably attached to or non-detachably attached to the body of the housing 230, such as at side surfaces of the partition wall portion 250, at an end surface of the partition wall portion 250, at a distal end of the body at opposing sides of the partition wall portion 250, at two meeting surfaces forming the step, etc.

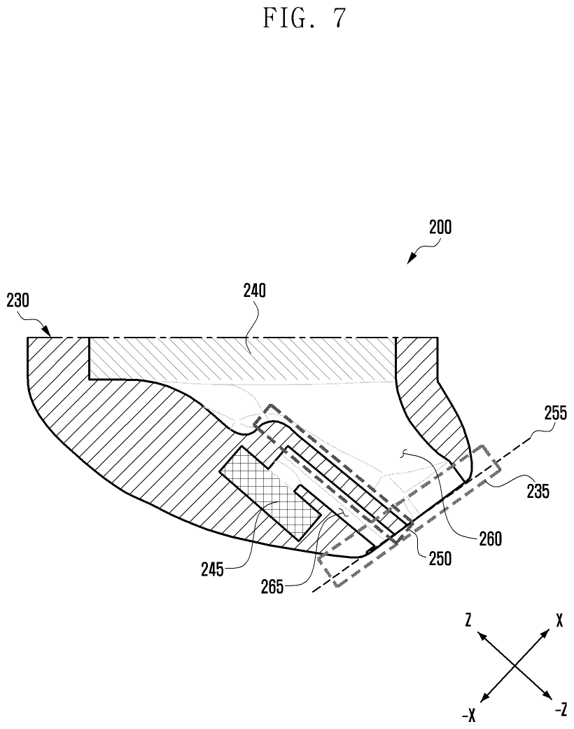

FIGS. 6A and 6B are cross-sectional diagrams illustrating the shapes of a partition wall portion 250 and a grill of a wearable electronic device 200 according to an embodiment of the disclosure.

In the wearable electronic device 200 shown in FIGS. 6A and 6B according to an embodiment, a housing 230, a nozzle part 235, a speaker 240, a microphone 245, a partition wall portion 250, a first sound conduit 260, and a second sound conduit 265 are substantially the same as the housing 230, the nozzle part 235, the speaker 240, the microphone 245, the partition wall portion 250, the first sound conduit 260, and the second sound conduit 265 of the wearable electronic device 200 shown in FIGS. 2A and 2B, so the description thereof can be replaced by the above description in FIGS. 2A and 2B.

With reference to FIG. 6A, the wearable electronic device 200 may include, as a part of the housing 230, the partition wall portion 250 which extends from a portion of the housing 230 and spatially separates the speaker 240 and the microphone 245 disposed in the internal space of the housing 230. A portion of the partition wall portion 250 may be formed to extend from a portion of the housing 230 and protrude outward (e.g., in the negative z-axis direction) from one surface 255 of the nozzle part 235.

In an embodiment, at least one portion 625 of the body of the housing 230 (e.g., at least one portion of the housing 230 adjacent to the second sound conduit 265) which forms at least a portion of the exterior of the wearable electronic device 200 may be formed to be longer in a specific direction (e.g., in the negative z-axis direction) beyond the one surface 255 of the nozzle part 235. The one portion 625 may define the second sound conduit 265 together with the partition wall portion 250. In an embodiment, the second sound conduit 265 may be formed to protrude outward (e.g., the negative z-axis direction) beyond the one surface 255 of the nozzle part 235. Accordingly, the end of the portion 625 of the housing 230, the end of the second sound conduit 265, and the end of the partition wall portion 250 may protrude from the one surface 255 by substantially the same length. In an embodiment, distal ends of each of the portion 625 of the housing 230, the second sound conduit 265 and the partition wall portion 250 may be coplanar with each other, without being limited thereto.

In an embodiment, the wearable electronic device 200 may include a grill detachably combined with the nozzle part 235 (or fixed to the nozzle part 235). For example, the grill may include a first grill 615 and a second grill 620. The first grill 615 may be disposed to surround at least one portion of the one surface 255 of the nozzle part 235 (e.g., at least one portion of the one surface 255 of the nozzle part 235 corresponding to the first sound conduit 260). The second grill 620 may be disposed to surround at least another portion of the one surface 255 of the nozzle part 235 (e.g., at least another portion of the one surface 255 of the nozzle part 235 corresponding to the second sound conduit 265) and at least a portion of the partition wall portion 250 formed to protrude outward (e.g., the negative z-axis direction) beyond the one surface 255 of the nozzle part 235.

In an embodiment, the first grill 615 and the second grill 620 may be formed in a shape parallel to the one surface 255 of the nozzle part 235. However, it is not limited to this.

In an embodiment, with reference to FIG. 6B, the wearable electronic device 200 may include, as a part of the housing 230, the partition wall portion 250 which extends from a portion of the housing 230 and spatially separates the speaker 240 and the microphone 245 disposed in the internal space of the housing 230. A portion of the partition wall portion 250 may be formed to extend from a portion of the housing 230 and protrude outward (e.g., in the negative z-axis direction) from one surface 255 of the nozzle part 235.

At least another portion 665 of the body of the housing 230 (e.g., at least another portion of the housing 230 adjacent to the first sound conduit 260) which forms at least a portion of the exterior of the wearable electronic device 200 may be formed to be longer in a specific direction (e.g., in the negative z-axis direction) beyond the one surface 255 of the nozzle part 235. The another portion 665 may define the first sound conduit 260 together with the partition wall portion 250. Accordingly, the end of a portion of the partition wall portion 250 formed to protrude outward (e.g., in the negative z-axis direction) beyond the one surface 255 of the nozzle part 235 and the end of the portion 665 of the housing 230 may protrude from the one surface 255 by substantially the same length. In an embodiment, distal ends of each of the portion 665 of the housing 230, the first sound conduit 260 and the partition wall portion 250 may be coplanar with each other, without being limited thereto.

In an embodiment, the wearable electronic device 200 may include the grill detachably combined with the nozzle part 235. It is not limited to this, and the grill may be formed to be fixed (e.g., un-detachable) to the nozzle part 235.

In an embodiment, the grill may include a first grill 655 and a second grill 660. The first grill 655 may be disposed to surround at least one portion of the one surface 255 of the nozzle part 235 (e.g., at least one portion of the one surface 255 of the nozzle part 235 corresponding to the first sound conduit 260) and at least a portion of the partition wall portion 250 formed to protrude outward (e.g., the negative z-axis direction) beyond the one surface 255 of the nozzle part 235. The second grill 660 may be disposed to surround at least another portion of the one surface 255 of the nozzle part 235 (e.g., at least another portion of the one surface 255 of the nozzle part 235 corresponding to the second sound conduit 265).

In an embodiment, the first grill 655 and the second grill 660 may be formed in a shape parallel to the one surface 255 of the nozzle part 235. However, it is not limited to this.

FIG. 7 is a diagram illustrating the shape of a partition wall portion 250 of a wearable electronic device 200 according to an embodiment of the disclosure.

In the wearable electronic device 200 shown in FIG. 7 according to an embodiment, a housing 230, a nozzle part 235, a speaker 240, a microphone 245, a first sound conduit 260, and a second sound conduit 265 are substantially the same as the housing 230, the nozzle part 235, the speaker 240, the microphone 245, the first sound conduit 260, and the second sound conduit 265 of the wearable electronic device 200 shown in FIGS. 2A and 2B, so the description thereof can be replaced by the above description in FIGS. 2A and 2B.

In FIGS. 2A and 2B according to various embodiments, it has been described that the partition wall portion 250 is a part of the housing 230 and a portion of the partition wall portion 250 is formed to protrude outward (e.g., in the negative z-axis direction) beyond the one surface 255 of the nozzle part 235, but it is not limited to this.

For example, with reference to FIG. 7, the partition wall portion 250 which is a part of the housing 230 may be formed to extend from a portion of the housing 230 to a length which ends at the one surface 255 of the nozzle part 235, thereby spatially separating the speaker 240 and the microphone 245 disposed in the internal space of the housing 230. Here, ends of the body of the housing 230 and the partition wall portion 250 are coplanar with each other, at the plane indicated by the one surface 255.

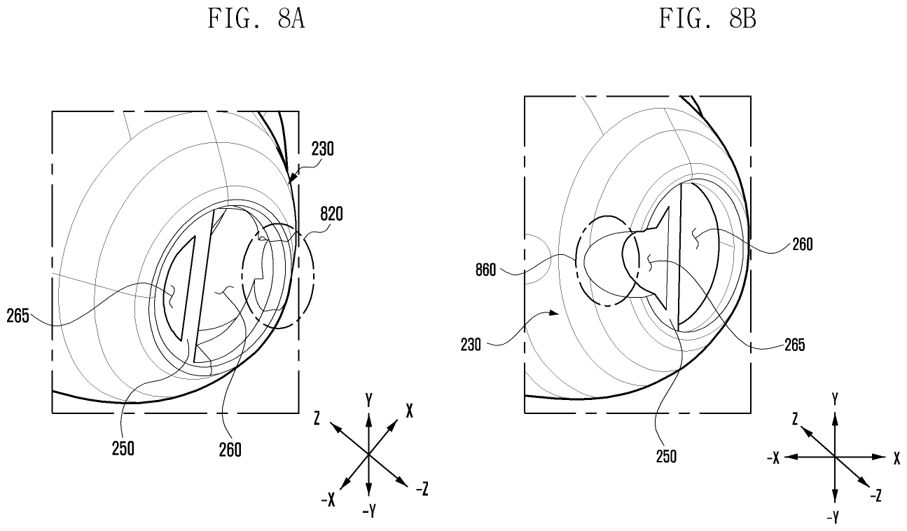

FIGS. 8A and 8B are perspective views illustrating at least one extension opening 820, 860 formed in a housing 230 of a wearable electronic device 200 according to an embodiment of the disclosure.

With reference to FIGS. 8A and 8B, the wearable electronic device 200 may include, as a part of the housing 230, the partition wall portion 250 formed to extend from at least a portion of the housing 230 to a length which can contact the one surface 255 of the nozzle part 235 so as to spatially separate the speaker 240 and the microphone 245 disposed in the internal space of the housing 230.

As seen in FIG. 7 according to an embodiment, the partition wall portion 250 may be formed, as a part of the housing 230, with a length which can contact or be coplanar with the one surface 255 of the nozzle part 235. In this case, as shown in FIG. 8A, a first extension opening 820 as a first opening extension may be formed in at least one partial area of the housing 230 adjacent to the one surface 255 of the nozzle part 235. For example, the first extension opening 820 may be formed to extend from the first sound conduit 260 in one direction (e.g., the x-axis direction). In an embodiment, where the first extension opening 820 extends in the x-axis direction, the first extension opening 820 may further extend into the body of the housing 230 along the z-axis direction. Here, as shown in FIG. 8A, the first sound conduit 260 may be exposed to outside the housing 230 not only in the negative z-axis direction, but also to the x-axis direction. Therefore, when the nozzle part 235 of the wearable electronic device 200 is clogged (e.g., when the nozzle part 235 is blocked at the plane of the one surface 255, such as by the user's hand), pressure may escape along the x-axis direction, through the extended area of the first extension opening 820.

It is not limited to this, and in an embodiment, when the partition wall portion 250 is formed, as a part of the housing 230, with a length which can contact the one surface 255 of the nozzle part 235, as shown in FIG. 8B, a second extension opening 860 as a second opening extension may be formed in at least another partial area of the housing 230 adjacent to at least another surface of the nozzle part 235. For example, the second extension opening 860 may be formed to extend from the second sound conduit 265 in another direction (e.g., the negative x-axis direction). In an embodiment, where the second extension opening 860 extends in the negative x-axis direction, the second extension opening 860 may further extend into the body of the housing 230 along the z-axis direction. Here, as shown in FIG. 8B, the second sound conduit 265 may be exposed to outside the housing 230 not only in the negative z-axis direction, but also to the negative x-axis direction. Therefore, when the nozzle part 235 of the wearable electronic device 200 is clogged (e.g., when the nozzle part 235 is blocked at the plane of the one surface 255, such as by the user's hand), pressure may escape along the negative x-axis direction, through the extended area of the second extension opening 860.

In an embodiment, when the partition wall portion 250 is formed, as a part of the housing 230, with a length which can contact the one surface 255 of the nozzle part 235, the first extension opening 820 may be formed in at least one partial area of the housing 230 (e.g., at least one partial area of the housing 230 adjacent to the first sound conduit 260) adjacent to the one surface 255 of the nozzle part 235, and the second extension opening 860 may be formed in at least another partial area of the housing 230 (e.g., at least another partial area of the housing 230 adjacent to the second sound conduit 265) adjacent to at least another surface of the nozzle part 235.

In FIGS. 7, 8A and 8B according to various embodiments, when the partition wall portion 250 is formed, as a part of the housing 230, with a length which can contact (or be coplanar with) the one surface 255 of the nozzle part 235, the first extension opening 820 and/or the second extension opening 860 are formed in at least partial area of the housing 230. Thus, when the nozzle part 235 of the wearable electronic device 200 is clogged (e.g., when the nozzle part 235 is blocked at the plane of the one surface 255, such as by the user's hand), pressure may escape through the extended areas of the first extension opening 820 and/or the second extension opening 860. As a result, a recursive signal which causes howling or echo is not formed between the speaker 240 and the microphone 245, so the features between the speaker 240 and the microphone 245 do not change, and the ANC performance can be improved.

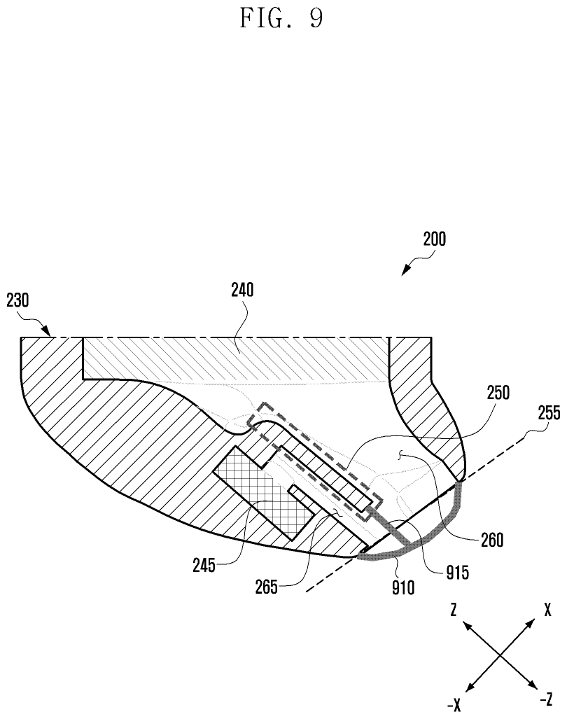

FIG. 9 is a diagram illustrating the shape of a partition wall portion 250 of a wearable electronic device 200 according to an embodiment of the disclosure.

According to various embodiments, it has been described in FIGS. 2A and 2B that a portion of the partition wall portion 250 is formed, as a part of the housing 230, to protrude outward (e.g., in the negative z-axis direction) beyond the one surface 255 of the nozzle part 235, and it has been described in FIG. 7 that the partition wall portion 250 is formed, as a part of the housing 230, with a length which can contact the one surface 255 of the nozzle part 235 to be coplanar therewith, it is not limited to these. For example, with reference to FIG. 9, the partition wall portion 250 may be formed inward (e.g., in the z-axis direction) compared to the one surface 255 of the nozzle part 235, to be spaced apart from the plane at the one surface 255.

In an embodiment, the wearable electronic device 200 may include a grill 910 detachably combined with the nozzle part 235 (or fixed to the nozzle part 235). The grill 910 may be disposed to surround the one surface 255 of the nozzle part 235. For example, the grill 910 may be formed in a curved shape. However, it is not limited to this.

In an embodiment, a protruding member 915 as a grill protrusion formed to extend inward (e.g., in the z-axis direction) from a portion of the grill 910 may be included. In an embodiment, when the partition wall portion 250 is formed inward (e.g., in the z-axis direction) compared to the one surface 255 of the nozzle part 235, a portion of the partition wall portion 250 may be connected to (or in contact with) the protruding member 915.

In FIG. 9 according to various embodiments, when the partition wall portion 250 is formed inward (e.g., in the z-axis direction) relative to the plane at the one surface 255 of the nozzle part 235, a portion of the partition wall portion 250 may be connected to (or in contact with) the protruding member 915, and thus the partition wall portion 250 and the protruding member 915 may spatially separate the speaker 240 and the microphone 245 disposed in the internal space of the housing 230, from each other. Therefore, audio signals outputted from the speaker 240 and transmitted to the microphone 245 become reduced, so that the speaker 240 can accurately generate noise having an opposite phase (e.g., noise representing a frequency with an opposite phase) to noise detected by the microphone 245 so as to cancel the external noise 305, thereby increasing ANC performance.

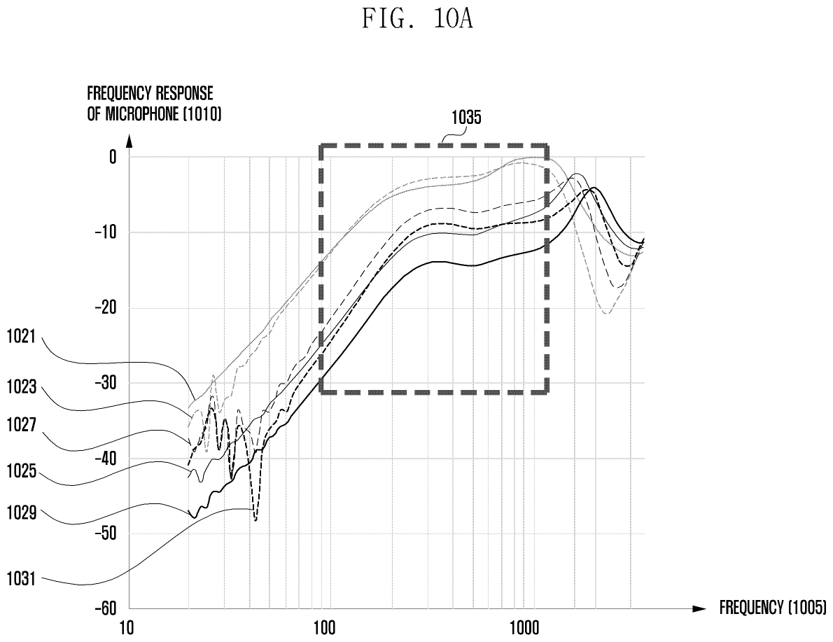

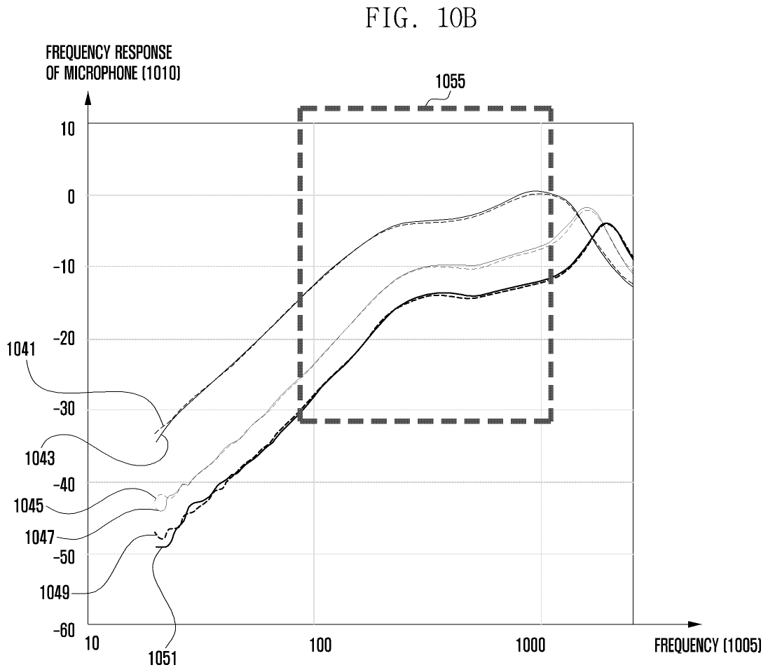

FIG. 10A is a graph showing the frequency response of a microphone 245 in a conventional case where the microphone 245 is not spatially separated from a speaker 240, according to an embodiment of the disclosure.

In FIG. 10A according to an embodiment, the x-axis denotes the frequency 1005 (in Hertz (Hz)), and the y-axis denotes the frequency response 1010 of the microphone 245 (in decibels (db)).

With reference to FIG. 10A, a first graph 1021, a third graph 1025, and a fifth graph 1029 show the frequency responses of the microphone 245 at the eardrum location in case which the speaker 240 and the microphone 245 are not spatially separated in a state where the wearable electronic device 200 is worn by being inserted into the user's ear (e.g., external auditory canal).

In an embodiment, a second graph 1023, a fourth graph 1027, and a sixth graph 1031 show the frequency responses of the microphone 245 at the location of the microphone 245 in case which the speaker 240 and the microphone 245 are not spatially separated in a state where the wearable electronic device 200 is worn by being inserted into the user's ear (e.g., external auditory canal).

In an embodiment, the first graph 1021 and the second graph 1023 show the frequency responses of the microphone 245 at the locations of the eardrum and the microphone 245, respectively, in a state of a first leakage (e.g., high leak). The third graph 1025 and the fourth graph 1027 show the frequency responses of the microphone 245 at the locations of the eardrum and the microphone 245, respectively, in a state of a second leakage (e.g., middle leak) smaller than the first leakage. The fifth graph 1029 and the sixth graph 1031 show the frequency responses of the microphone 245 at the locations of the eardrum and the microphone 245, respectively, in a state of a third leakage (e.g., low leak) smaller than the second leakage.

As shown in FIG. 10A, the first graph 1021 and the second graph 1023 showing the frequency responses of the microphone 245 at the locations of the eardrum and the microphone 245, respectively, in a low frequency band 1035 (e.g., about 100 Hz to about 1000 Hz) and in the first leakage state may be similar. The third graph 1025 and the fourth graph 1027 showing the frequency responses of the microphone 245 at the locations of the eardrum and the microphone 245, respectively, in the low frequency band 1035 (e.g., 100 Hz to 1000 Hz) and in the second leakage state may be different (e.g., a difference of about 2 dB to about 3 dB may occur in the frequency response 1010 of the microphone 245). The fifth graph 1029 and the sixth graph 1031 showing the frequency responses of the microphone 245 at the locations of the eardrum and the microphone 245, respectively, in the low frequency band 1035 (e.g., about 100 Hz to about 1000 Hz) and in the third leakage state may be different (e.g., a difference of about 3 dB to about 5 dB may occur in the frequency response 1010 of the microphone 245).

As described above, the third graph 1040 and fourth graph 1045 in the low frequency band 1035 (e.g., about 100 Hz to about 1000 Hz) and the second leakage state may be different and the fifth graph 1050 and the sixth graph 1055 in the low frequency band 1035 (e.g., about 100 Hz to about 1000 Hz) and third leakage state may be different. In other words, the greater the leakage in the low frequency band 1035 (e.g., about 100 Hz to about 1000 Hz), the more there will be a difference between the frequency response of the microphone 245 at the eardrum location and the frequency response of the microphone 245 at the location of the microphone 245. This means that ANC performance is low.

FIG. 10B is a graph showing the frequency response of a microphone 245 in the case where the microphone 245 is spatially separated from a speaker 240 by a partition wall portion 250, according to an embodiment of the disclosure.

In FIG. 10B according to an embodiment, the x-axis denotes the frequency 1005 (in Hz), and the y-axis denotes the frequency response 1010 of the microphone 245 (in dB).

With reference to FIG. 10B, a seventh graph 1041, a ninth graph 1045, and an eleventh graph 1049 show the frequency responses of the microphone 245 at the location of the microphone 245 in case which the speaker 240 and the microphone 245 are spatially separated by the partition wall portion 250 in a state where the wearable electronic device 200 is worn by being inserted into the user's ear (e.g., external auditory canal). In an embodiment, an eighth graph 1043, a tenth graph 1047, and a twelfth graph 1051 show the frequency responses of the microphone 245 at the eardrum location in case which the speaker 240 and the microphone 245 are spatially separated by the partition wall portion 250 in a state where the wearable electronic device 200 is worn by being inserted into the user's ear (e.g., external auditory canal).

In an embodiment, the seventh graph 1041 and the eighth graph 1043 show the frequency responses at the locations of the microphone 245 and the eardrum, respectively, in a state of a first leakage (e.g., high leak). The ninth graph 1045 and the tenth graph 1047 show the frequency responses at the locations of the microphone 245 and the eardrum, respectively, in a state of a second leakage (e.g., middle leak) smaller than the first leakage. The eleventh graph 1049 and the twelfth graph 1051 show the frequency responses at the locations of the microphone 245 and the eardrum, respectively, in a state of a third leakage (e.g., low leak) smaller than the second leakage.

As shown in FIG. 10B, the seventh graph 1041 and the eighth graph 1043 showing the frequency responses of the microphone 245 at the locations of the microphone 245 and the eardrum, respectively, in a low frequency band 1055 (e.g., about 100 Hz to about 1000 Hz) and in the first leakage state may be similar. The ninth graph 1045 and the tenth graph 1047 showing the frequency responses of the microphone 245 at the locations of the microphone 245 and the eardrum, respectively, in the low frequency band 1055 (e.g., about 100 Hz to about 1000 Hz) and in the second leakage state may be similar. The eleventh graph 1049 and the twelfth graph 1051 showing the frequency responses of the microphone 245 at the locations of the microphone 245 and the eardrum, respectively, in the low frequency band 1055 (e.g., about 100 Hz to about 1000 Hz) and in the third leakage state may be similar).

In an embodiment, for respective leakage states in the low frequency band 1055 (e.g., about 100 Hz to about 1000 Hz), the seventh graph 1041 and the eighth graph 1043 are similar, the ninth graph 1045 and the tenth graph 1047 are similar, and the eleventh graph 1049 and the twelfth graph 1051 are similar, so it can be seen that the frequency response at the location of the microphone 245 and the frequency response at the eardrum location are similar. This means that ANC performance is high. In other words, compared to the conventional one, in an embodiment of the disclosure where the speaker 240 and the microphone 245 are spatially separated by the partition wall portion 250, there is no difference between the frequency response of the microphone 245 at the eardrum location and the frequency response of the microphone 245 at the location of the microphone 245 even when the leakage increases in the low frequency band (e.g., about 100 Hz to about 1000 Hz), so ANC performance becomes high. According as no difference occurs between the frequency response of the microphone 245 at the eardrum location and the frequency response of the microphone 245 at the location of the microphone 245 even when the leakage increases in the low frequency band (e.g., about 100 Hz to about 1000 Hz), the speaker 240 can cancel noise by accurately generating noise having an opposite phase (e.g., noise representing a frequency with an opposite phase) to noise detected by the microphone 245, and thus it is possible to achieve high ANC performance even in the first leakage state, the second leakage state, and the third leakage state.

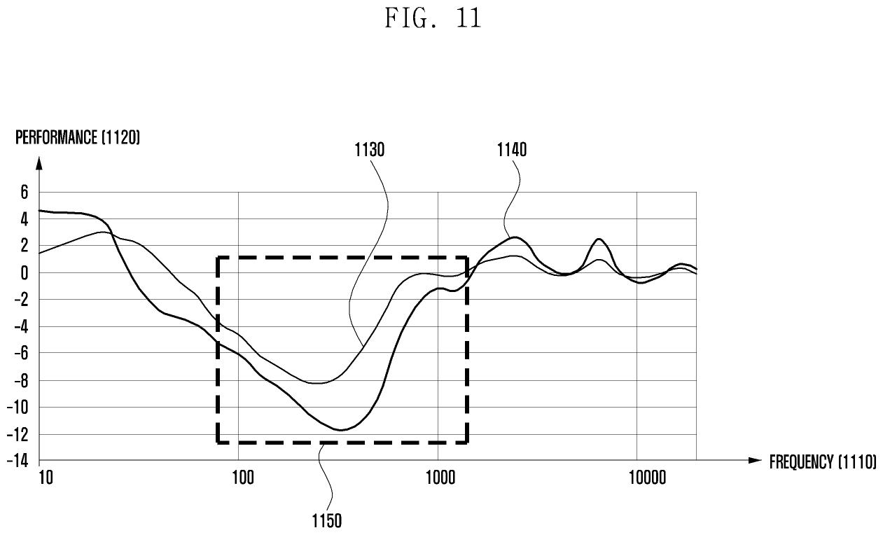

FIG. 11 is a graph showing ANC performance in various cases of separation of a speaker 240 and a microphone 245.

In FIG. 11 according to an embodiment, the x-axis denotes the frequency 1110 (in Hz), and the y-axis denotes the ANC performance 1120.

With reference to FIG. 11, a first graph 1130 shows the ANC performance 1120 in a state where the speaker 240 and the microphone 245 are not spatially separated by the partition wall portion 250. A second graph 1140 shows the ANC performance 1120 in a state where the speaker 240 and the microphone 245 are spatially separated by the partition wall portion 250.

In an embodiment, the speaker 240 may output noise having an opposite phase (e.g., noise representing a frequency with an opposite phase) to noise detected by the microphone 245 so as to cancel noise. For example, in the graphs shown in FIG. 11, a lower value of the ANC performance 1120 means that the performance of canceling the noise is higher. In comparison between the first graph 1130 and the second graph 1140 in the low frequency band 1150 (e.g., about 100 Hz to about 1000 Hz), it can be seen that the ANC performance 1120 is low in the second graph 1140. Accordingly, ANC performance 1120 can be high when the speaker 240 and the microphone 245 are spatially separated by the partition wall portion 250.

A wearable electronic device 101 or 200 according to an embodiment of the disclosure may include a housing 230 forming at least a portion of an exterior of the wearable electronic device 101 or 200. The wearable electronic device 101 or 200 according to an embodiment may include a nozzle part 235 formed on one side of the housing 230. The wearable electronic device 101 or 200 according to an embodiment may include a speaker 240 disposed to correspond to a first sound conduit 260 in an internal space of the housing 230. The wearable electronic device 101 or 200 according to an embodiment may include a microphone 245 disposed to correspond to a second sound conduit 265 in the internal space of the housing 230. The wearable electronic device 101 or 200 according to an embodiment may include a partition wall portion 250 extending from a portion of the housing 230 and spatially separating the speaker 240 and the microphone 245 in the internal space of the housing 230. A portion of the partition wall portion 250 according to an embodiment may be formed to protrude outward beyond one surface 255 of the nozzle part 235.

Here, a wearable electronic device includes a housing forming an exterior of the wearable electronic device, a first sound conduit and a second sound conduit disposed in an internal space of the housing, and a nozzle part through which the audio signals transmit both into and out of the housing, the nozzle part including an end surface of the housing (e.g., end surface along plane at the one surface 255), a partition wall (e.g., the partition wall portion 250) in the internal space of the housing and spatially separating the internal space into the first sound conduit and the second sound conduit, a speaker disposed to correspond to the first sound conduit in the internal space of the housing, and a microphone disposed to correspond to the second sound conduit in the internal space of the housing. A portion of the partition wall extends further than the end surface of the housing.

The first sound conduit 260 according to an embodiment may be a path of audio signals outputted from the speaker 240. The second sound conduit 265 according to an embodiment may be a path of audio signals received by the microphone 245. For example, the first sound conduit transmit the audio signals which is output from the speaker, to outside of the housing, through the nozzle part, and the second sound conduit transmit the audio signals which is input from the outside of the housing, through the nozzle part, to the microphone.

In an embodiment, the audio signals outputted from the speaker 240 through the first sound conduit 260 may be prevented from being transmitted to the microphone 245 through the second sound conduit 265 by the partition wall portion 250. That is, the audio signal which is transmitted to outside of the housing by the first sound conduit is excluded from the second sound conduit, by the partition wall. Here, the audio signal can be isolated from the microphone.

The wearable electronic device 101 or 200 according to an embodiment may further include a grill 270 disposed on the nozzle part 235. The grill 270 discloses an audio signal-permeable member on the nozzle part.

In an embodiment, the grill 270 may be disposed to surround the one surface 255 of the nozzle part 235 and a portion of the partition wall portion 250 protruding outward beyond the one surface 255 of the nozzle part 235. That is, the audio signal-permeable member extends across the nozzle part and the portion of the partition wall which extends further than the end surface of the housing.

In an embodiment, the grill 270 may be formed in a curved shape.

In an embodiment, the grill 270 may include a first grill 270a disposed to surround at least one portion of the one surface 255 of the nozzle part 235. In an embodiment, the grill 270 may include a second grill 270b disposed to surround at least another portion of the one surface 255 of the nozzle part 235. For example, the audio signal-permeable member includes a first grill extending across the nozzle part at the first sound conduit, and a second grill extending across the nozzle part at the second sound conduit.

In an embodiment, the grill 270 may include a first grill 515 disposed to surround at least one portion of the one surface 255 of the nozzle part 235 and a portion of the partition wall portion 250 formed to protrude outward beyond the one surface 255 of the nozzle part 235. In an embodiment, the grill 270 may include a second grill 520 disposed to surround at least another portion of the one surface 255 of the nozzle part 235. That is, the audio signal-permeable member includes a first grill extending from an end of the partition wall and across the nozzle part at the first sound conduit, and a second grill separated from the first grill, the second grill extending from the partition wall and across the nozzle part at the second sound conduit.

In an embodiment, the grill 270 may include a first grill 615 disposed to surround at least one portion of the one surface 255 of the nozzle part 235. In an embodiment, the grill 270 may include a second grill 620 disposed to surround at least another portion of the one surface 255 of the nozzle part 235 and a portion of the partition wall portion 250 formed to protrude outward beyond the one surface 255 of the nozzle part 235. That is, the audio signal-permeable member includes a first grill extending from the partition wall and across the nozzle part at the first sound conduit, and a second grill separated from the first grill, the second grill extending from an end of the partition wall and across the nozzle part at the second sound conduit.

In an embodiment, a portion of the partition wall portion 250 may be formed to be parallel to the one surface 255 of the nozzle part 235, instead of being formed to protrude outward beyond the one surface 255 of the nozzle part 235. For example, the partition wall includes a surface (e.g., end of 525b or 565a) which is coplanar with the end surface of the housing, and the portion of the partition wall extending from the surface and further than the end surface of the housing.

In an embodiment, in case which the portion of the partition wall portion 250 is formed parallel to the one surface 255 of the nozzle part 235, a first extension opening 820 may be formed in at least one partial area of the housing 230 adjacent to at least one portion of the one surface 255 of the nozzle part 235. For example, the end surface of the housing is disposed in a plane (e.g., at the one surface 255), the nozzle part includes a first opening and a second opening, the first opening and the second opening being coplanar with the end surface of the housing, and the first opening is extended in a direction away from the plane to define a first extension opening.

In an embodiment, in case which the portion of the partition wall portion 250 is formed parallel to the one surface 255 of the nozzle part 235, a second extension opening 860 may be formed in at least another partial area of the housing 230 adjacent to at least another portion of the one surface 255 of the nozzle part 235. Here, the second opening is extended in a direction away from the plane to define a second extension opening.

In an embodiment, a portion of the partition wall portion 250 may be formed inward compared to the one surface 255 of the nozzle part 235, instead of being formed to protrude outward beyond the one surface 255 of the nozzle part 235. Here, the partition wall includes an end which is within the internal space and spaced apart from the end surface of the housing.

The wearable electronic device 101 or 200 according to an embodiment may further include a grill 910 disposed on the nozzle part 235.

In an embodiment, the grill 910 may include a protruding member 915 formed to extend inward from a portion of the grill 910.

In an embodiment, in case which the portion of the partition wall portion 250 is formed inward compared to the one surface 255 of the nozzle part 235, the portion of the partition wall portion 250 may be connected to the protruding member 915.

The first sound conduit 260 according to an embodiment may be a path of audio signals outputted from the speaker 240. The second sound conduit 265 according to an embodiment may be a path of audio signals received by the microphone 245.

In an embodiment, the audio signals outputted from the speaker 240 through the first sound conduit 260 may be prevented from being transmitted to the microphone 245 through the second sound conduit 265 by the partition wall portion 250 and the protruding member 915.

In an embodiment, the microphone 245 may include an active noise canceling microphone for removing noise inside the wearable electronic device 101 or 200.

In an embodiment, the speaker 240 may generate offset noise having an opposite phase to noise detected by the microphone 245, thereby canceling the noise.

For example, the microphone includes an active noise canceling microphone which detects noise inside the wearable electronic device, and the speaker generates offset noise having an opposite phase to that of the noise detected by the microphone to cancel the noise within the wearable electronic device.

In another embodiment, a wearable electronic device includes the partition wall including a surface (like 525b and 565a in FIGS. 5A and 5B) which is coplanar with the end surface of the housing (refer to FIGS. 5A, 5B and 7, for example). The partition wall may further include an extended portion (like 525a and 565b in FIGS. 5A and 5B) which extends from the surface of the partition wall and further than the end surface of the housing to define an end surface of the partition wall. The surface and the extended portion of the partition wall forms a step of the partition wall (refer to FIGS. 5A and 5B, for example). A portion (like 520 in FIG. 5A or 555 in FIG. 5B) of the audio signal-permeating member is parallel (or coplanar) with the end surface of the housing.

A wearable electronic device according to an embodiment of the disclosure may include a housing forming an exterior of the wearable electronic device. The wearable electronic device 101 or 200 according to an embodiment may include a first sound conduit and a second sound conduit disposed in an internal space of the housing. The wearable electronic device 101 or 200 according to an embodiment may include a nozzle part through which the audio signals transmit both into and out of the housing. The nozzle part including an end surface of the housing. The wearable electronic device 101 or 200 according to an embodiment may include a partition wall in the internal space of the housing and spatially separating the internal space into the first sound conduit and the second sound conduit. The wearable electronic device 101 or 200 according to an embodiment may include a speaker disposed to correspond to the first sound conduit in the internal space of the housing. The wearable electronic device 101 or 200 according to an embodiment may include a microphone disposed to correspond to the second sound conduit in the internal space of the housing. The partition wall comprises a surface which is coplanar with the end surface of the housing.

The partition wall further comprises an extended portion which extends from the surface of the partition wall and further than the end surface of the housing to define an end surface of the partition wall.

The surface and the extended portion of the partition wall forms a step of the partition wall.

The wearable electronic device 101 or 200 according to an embodiment may include an audio signal-permeable member on the nozzle part. A portion of the audio signal-permeating member is parallel with the end surface of the housing.

The portion of the audio signal-permeating member which is coplanar with the end surface of the housing extends across the first sound conduit.

The portion of the audio signal-permeating member which is coplanar with the end surface of the housing extends across the second sound conduit.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements.

It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases.

As used herein, such terms as “1st” and “2nd,” or “first” and “second” may be used to simply distinguish a corresponding component from another, and does not limit the components in other aspect (e.g., importance or order).

It is to be understood that if an element (e.g., a first element) is referred to, with or without the term “operatively” or “communicatively,” as “coupled with,” “coupled to,” “connected with,” or “connected to” another element (e.g., a second element), it means that the element may be coupled with the other element directly (e.g., through wires), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry.” A module may be a single integral component, or a minimum unit or part thereof, adapted to perform one or more functions. For example, according to an embodiment, the module may be implemented in a form of an application-specific integrated circuit (ASIC).

Various embodiments as set forth herein may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a complier or a code executable by an interpreter. The machine-readable storage medium may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to various embodiments of the disclosure may be included and provided in a computer program product. The computer program product may be traded as a product between a seller and a buyer. The computer program product may be distributed in the form of a machine-readable storage medium (e.g., compact disc read only memory (CD-ROM)), or be distributed (e.g., downloaded or uploaded) online via an application store (e.g., PlayStore™), or between two user devices (e.g., smart phones) directly. If distributed online, at least part of the computer program product may be temporarily generated or at least temporarily stored in the machine-readable storage medium, such as memory of the manufacturer's server, a server of the application store, or a relay server.

According to various embodiments, each component (e.g., a module or a program) of the above-described components may include a single entity or multiple entities, and some of the multiple entities may be separately disposed in different components. According to various embodiments, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be understood that when an element is referred to as being related to another element such as being “on” another element, it can be directly on the other element or intervening elements may be present therebetween. In contrast, when an element is referred to as being related to another element such as being “directly on” another element, there are no intervening elements present. Elements being in contact or being “directly” related to each other, may form an interface therebetween.

The terminology used herein is for the purpose of describing particular embodiments only and is not intended to be limiting. As used herein, “a”, “an,” “the,” and “at least one” do not denote a limitation of quantity, and are intended to include both the singular and plural, unless the context clearly indicates otherwise. Thus, reference to “an” element in a claim followed by reference to “the” element is inclusive of one element and a plurality of the elements. For example, “an element” has the same meaning as “at least one element,” unless the context clearly indicates otherwise. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +30%, 20%, 10% or 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

What is claimed is:

1. A wearable electronic device comprising:
a housing forming an exterior of the wearable electronic device;
a first sound conduit and a second sound conduit disposed in an internal space of the housing;
a nozzle part through which the audio signals transmit both into and out of the housing, the nozzle part including an end surface of the housing;
a partition wall in the internal space of the housing and spatially separating the internal space into the first sound conduit and the second sound conduit;
a speaker disposed to correspond to the first sound conduit in the internal space of the housing; and
a microphone disposed to correspond to the second sound conduit in the internal space of the housing,
wherein a portion of the partition wall extends further than the end surface of the housing.

2. The wearable electronic device of claim 1, wherein
the first sound conduit transmit the audio signals which is output from the speaker, to outside of the housing, through the nozzle part, and
the second sound conduit transmit the audio signals which is input from the outside of the housing, through the nozzle part, to the microphone.

3. The wearable electronic device of claim 2, wherein the audio signal which is transmitted to outside of the housing by the first sound conduit is excluded from the second sound conduit, by the partition wall.

4. The wearable electronic device of claim 1, further comprising an audio signal-permeable member on the nozzle part.

5. The wearable electronic device of claim 4, wherein the audio signal-permeable member extends across the nozzle part and the portion of the partition wall which extends further than the end surface of the housing.

6. The wearable electronic device of claim 5, wherein the audio signal-permeable member has a curved shape.

7. The wearable electronic device of claim 4, wherein the audio signal-permeable member includes:
a first grill extending across the nozzle part at the first sound conduit, and
a second grill extending across the nozzle part at the second sound conduit.

8. The wearable electronic device of claim 4, wherein the audio signal-permeable member includes:
a first grill extending from an end of the partition wall and across the nozzle part at the first sound conduit, and
a second grill separated from the first grill, the second grill extending from the partition wall and across the nozzle part at the second sound conduit.

9. The wearable electronic device of claim 4, wherein the audio signal-permeable member includes:
a first grill extending from the partition wall and across the nozzle part at the first sound conduit, and
a second grill separated from the first grill, the second grill extending from an end of the partition wall and across the nozzle part at the second sound conduit.

10. The wearable electronic device of claim 1, wherein the partition wall comprises:
a surface which is coplanar with the end surface of the housing, and
the portion of the partition wall extending from the surface and further than the end surface of the housing.

11. The wearable electronic device of claim 10, wherein
the end surface of the housing is disposed in a plane;
the nozzle part includes a first opening and a second opening;
the first opening and the second opening being coplanar with the end surface of the housing; and
the first opening is extended in a direction away from the plane to define a first extension opening.

12. The wearable electronic device of claim 11, wherein the second opening is extended in a direction away from the plane to define a second extension opening.

13. The wearable electronic device of claim 1, wherein
the microphone includes an active noise canceling microphone which detects noise inside the wearable electronic device, and
the speaker generates offset noise having an opposite phase to that of the noise detected by the microphone to cancel the noise within the wearable electronic device.

14. A wearable electronic device comprising:
a housing forming an exterior of the wearable electronic device;
a first sound conduit and a second sound conduit disposed in an internal space of the housing;
a nozzle part through which the audio signals transmit both into and out of the housing, the nozzle part including an end surface of the housing;
a partition wall in the internal space of the housing and spatially separating the internal space into the first sound conduit and the second sound conduit;
a speaker disposed to correspond to the first sound conduit in the internal space of the housing; and
a microphone disposed to correspond to the second sound conduit in the internal space of the housing,
wherein the partition wall comprises an end which is within the internal space and spaced apart from the end surface of the housing.

15. The wearable electronic device of claim 14, further comprising an audio signal-permeable member on the nozzle part.

16. The wearable electronic device of claim 15, wherein the audio signal-permeable member extends across the nozzle part and includes a protruding member extended inward toward the end of the partition wall.

17. The wearable electronic device of claim 16, wherein the audio signal-permeable member is connected to the end of the partition wall at the protruding member.

18. The wearable electronic device of claim 14, wherein
the first sound conduit transmits an audio signal among the audio signals which is output from the speaker, to outside of the housing, through the nozzle part, and
the second sound conduit transmits an audio signal among the audio signals which is input from the outside of the housing, through the nozzle part, to the microphone.

19. The wearable electronic device of claim 18, wherein the audio signal which is transmitted to outside of the housing by the first sound conduit is excluded from the second sound conduit, by the partition wall and the protruding member.

20. The wearable electronic device of claim 13, wherein
the microphone includes an active noise canceling microphone which detects noise inside the wearable electronic device, and
the speaker generates offset noise having an opposite phase to that of the noise detected by the microphone to cancel the noise within the wearable electronic device.
